(19) United States
(12) Patent Application Publication
(10) Pub. No.: US 2015/0247356 A1
(43) Pub. Date: Sep. 3, 2015

(54) Condensation Elimination System

(71) Applicant: Chad M. Ahlbrecht, Carlos, MN (US)

(72) Inventor: Chad M. Ahlbrecht, Carlos, MN (US)

(21) Appl. No.: 14/697,842

(22) Filed: Apr. 28, 2015

Related U.S. Application Data
(63) Continuation-in-part of application No. 13/484,366, filed on May 31, 2012.

(51) Int. Cl. E06B 7/12

(52) U.S. Cl. CPC E06B 7/12

(57) ABSTRACT

A Condensation Elimination System for automatically preventing and/or eliminating any condensation which forms on a window in colder conditions. The Condensation Elimination System generally includes housing with an air vent at its rear end and an airflow slot at its front end. The interior of the housing includes a plurality of discrete compartments which are separated by compartment walls. The compartment walls may include airflow guides which direct air being blown from a fan at the air vent through the housing and out the airflow slot to eliminate condensation on a window. The housing is secured against the window such as by use of mounts and receivers. A battery and solar panel may be used for power and a control circuit may direct overall operation of the invention.

### CROSS REFERENCE TO RELATED APPLICATIONS

I hereby claim benefit under Title 35, United States Code, Section 120 of U.S. patent application Ser. No. 13/484,366 filed May 31, 2012. This application is a continuation-in-part of the Ser. No. 13/484,366 application. The Ser. No. 13/484,366 application is currently pending. The Ser. No. 13/484,366 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a condensation elimination system and more specifically it relates to a window condensation elimination system for automatically preventing and/or eliminating any condensation which forms on a window in colder conditions.

2. Description of the Related Art

Any discussion of the related art throughout the specification should in no way be considered as an admission that such related art is widely known or forms part of common general knowledge in the field.

In colder environments where temperatures drop below around 35 degrees Fahrenheit, condensation will generally form on any windows. This condensation can decrease or eliminate visibility through the window and thus negatively impact the aesthetic appeal of the room. Further, condensation can create mold and mildew which can rot the window frame; thus necessitating its replacement. Additionally, ice can form which can make it difficult or in some cases impossible to open the window if needed.

In the past, an individual wishing to prevent or eliminate such condensation has had to rely on manually operated and placed fans. Alternatively, the individual is required to continuously wipe off the window, which in many cases can lead to unsightly streaks or a repeating cycle of condensation continuously building up, being wiped off and then building up again.

Because of the inherent problems with the related art, there is a need for a new and improved condensation elimination system for automatically preventing and/or eliminating any condensation which forms on a window in colder conditions.

### BRIEF SUMMARY OF THE INVENTION

The invention generally relates to a condensation elimination system which includes a housing with an air vent at its rear end and an airflow slot at its front end. The interior of the housing includes a plurality of discrete compartments which are separated by compartment walls. The compartment walls may include airflow guides which direct air being blown from a fan at the air vent through the housing and out the airflow slot to eliminate condensation on a window. The housing is secured against the window such as by use of mounts and receivers. A battery and solar panel may be used for power and a control circuit may direct overall operation of the invention.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a frontal upper perspective view of the present invention.

FIG. 2 is a rear upper perspective view of the present invention.

FIG. 3 is a bottom perspective view of the present invention.

FIG. 4 is a frontal view of the present invention.

FIG. 5 is a rear view of the present invention.

FIG. 6 is a top sectional view of the present invention.

FIG. 7 is a bottom view of the present invention.

FIG. 8 is an upper perspective view of the present invention with the cover, battery, and fan removed.

FIG. 9 is a rear cutaway view of the present invention.

FIG. 10 is a top cutaway view of the present invention.

FIG. 11 is a sectional view taken along line 11-11 of FIG. 6.

FIG. 12 is a sectional view taken along line 12-12 of FIG. 6.

FIG. 13 is a sectional view taken along line 13-13 of FIG. 6.

FIG. 14 is a sectional side view of the present invention in use.

FIG. 15 is a block diagram of the present invention.

### DETAILED DESCRIPTION OF THE INVENTION

### A. Overview

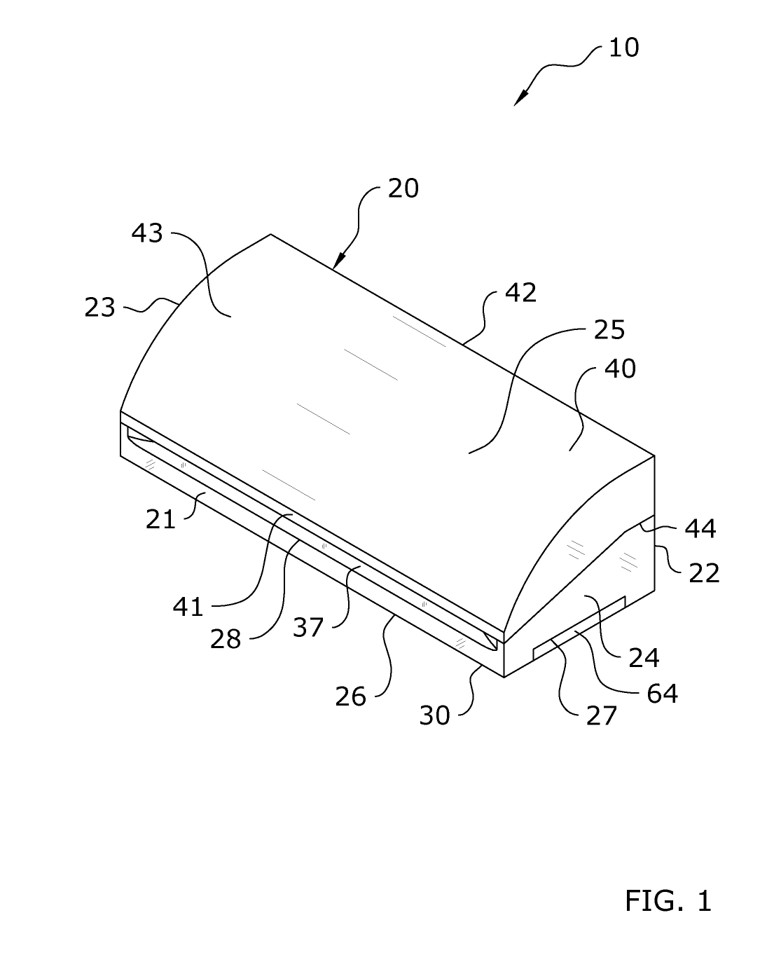

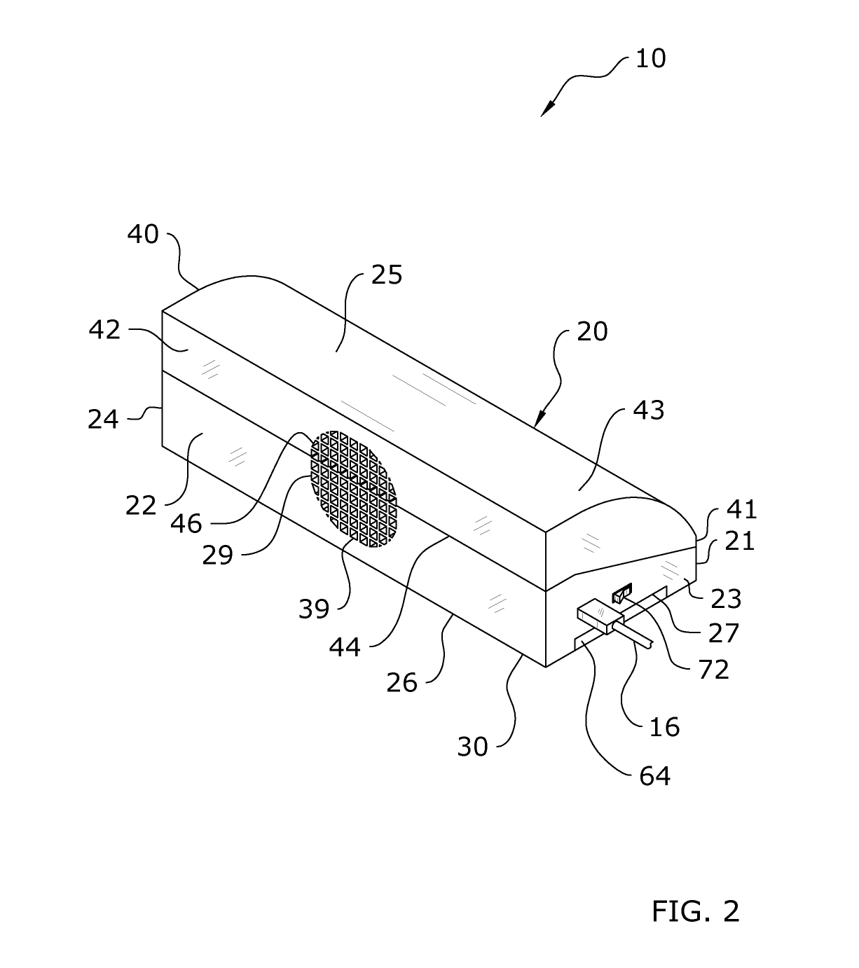

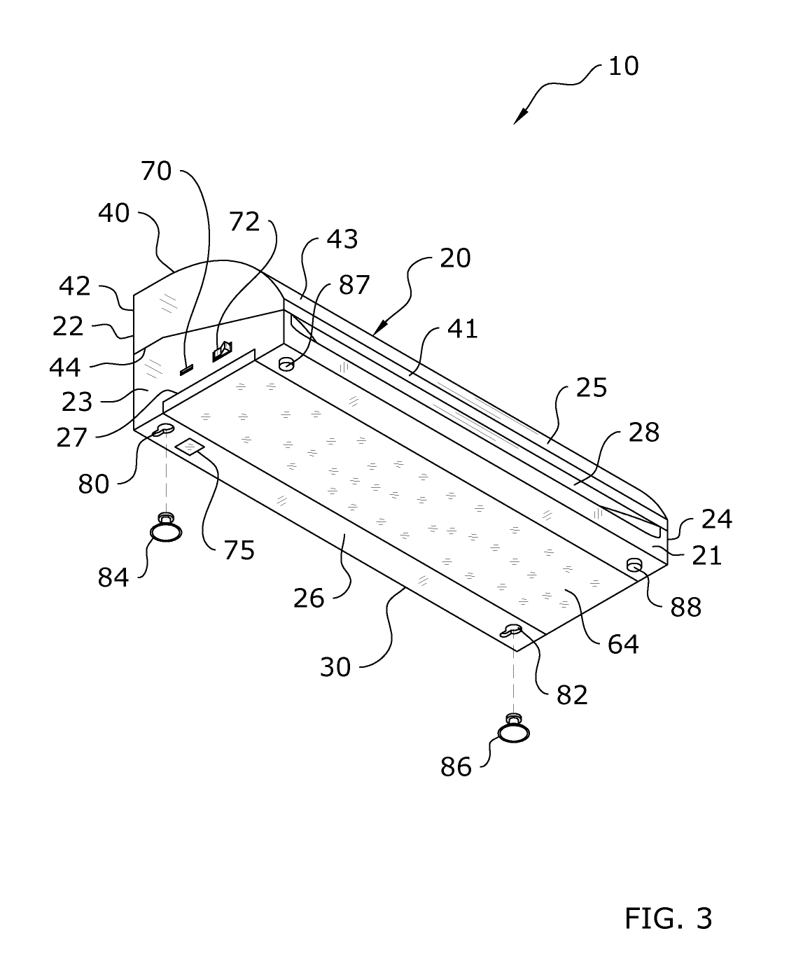

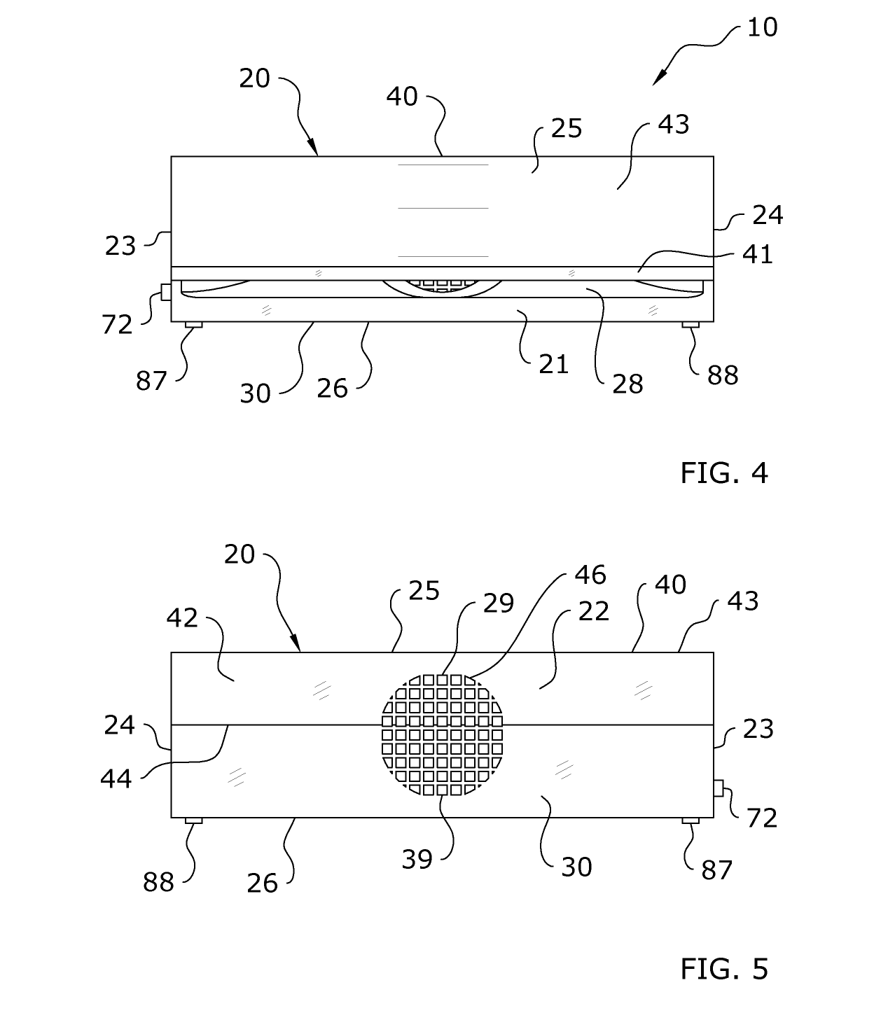

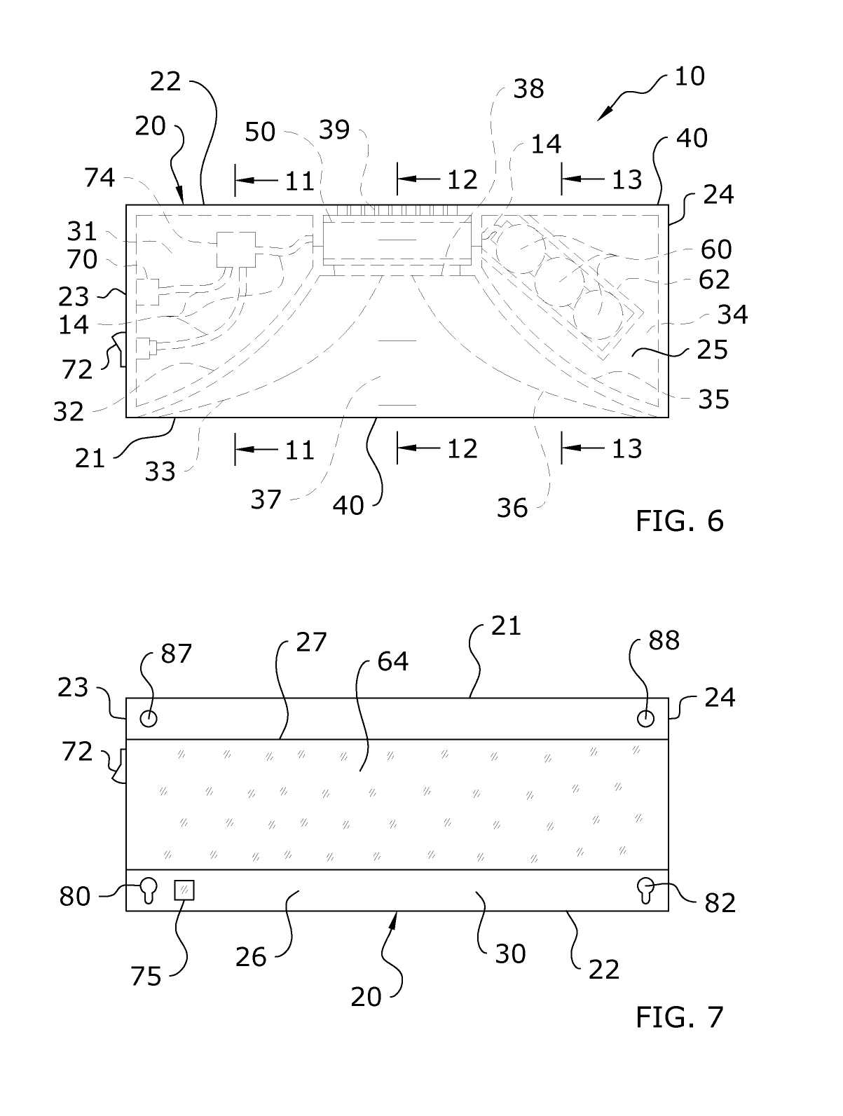

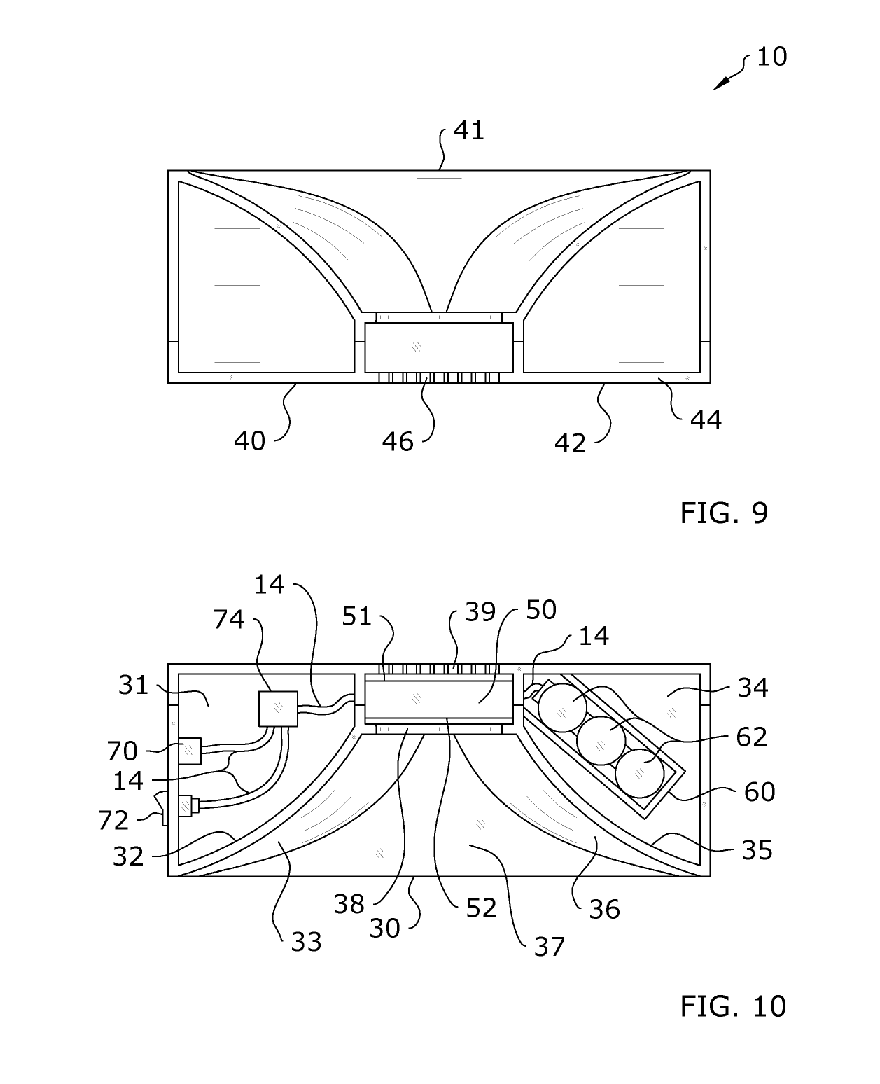

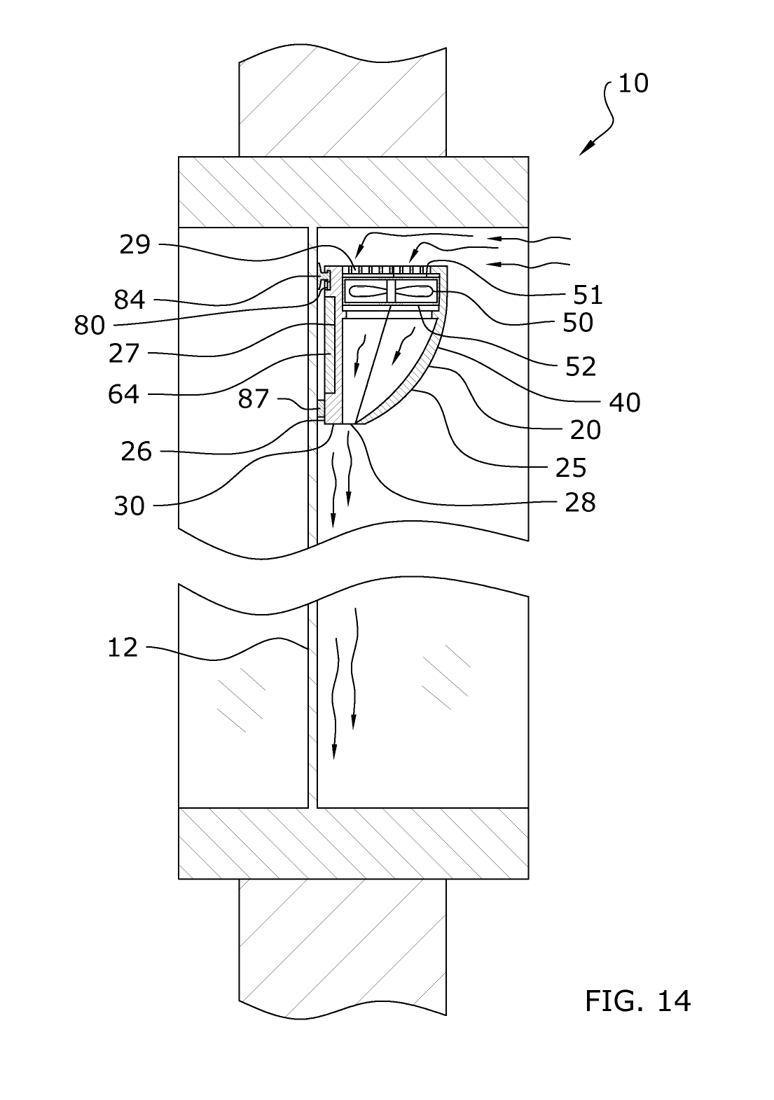

Turning now descriptively to the drawings, in which similar reference characters denote similar elements throughout the several views, FIGS. 1 through 15 illustrate a Condensation Elimination System 10, which comprises a housing 20 with an air vent 29 at its rear end 22 and an airflow slot 28 at its front end 21. The interior of the housing 20 includes a plurality of discrete compartments 31, 34, 37 which are separated by compartment walls 32, 35. The compartment walls 32, 35 may include airflow guides 33, 36 which direct air being blown from a fan 50 at the air vent 29 through the housing 20 and out the airflow slot 28 to eliminate condensation on a window 12. The housing 20 is secured against the window 12 such as by use of mounts 84, 86 and receivers 80, 82. A battery 62 and solar panel 64 may be used for power and a control circuit 74 may direct overall operation of the invention.

### B. Housing

As shown throughout the figures, the present invention includes a housing 20 which is secured to a surface such as a window 12 for elimination of condensation thereon. The structure, shape, size, and configuration of the housing 20 may vary in different embodiments of the present invention and thus should not be construed as limited by the exemplary figures. Although the figures illustrate that the housing 20 comprises a base portion 30 and a cover portion 40 which is removably secured to the base portion 30, it should be appreciated that in some embodiments the present invention may comprise a unitary structure which is integrally formed and thus not comprise two separable portions.

As shown in FIGS. 1-3, the housing 20 generally includes a front end 21, a rear end 22, a first side 23, a second side 24, an upper end 25, and a lower end 26. Air is blown through the front end 21 of the housing 20 while it is drawn in through the rear end 22 of the housing 20 by a fan 50. Thus, the front end 21 of the housing 20 will generally include an airflow slot 28 through which the air may be blown out of the housing 20. The rear end 22 of the housing 20 includes an air vent 29 through which air is drawn into the housing 20 by the fan 50.

The first side 23 will generally include a switch 72 for powering on and off the device as well as an optional connector port 70, such as for connecting a USB power cord 16. However, it should be appreciated that the switch 72 and/or connector port 70 could be located at various other positions on the housing 20, such as on the second side 24.

The lower end 26 of the housing 20 is secured against a surface such as a window 12. The lower end 26 of the housing 20 will generally include a solar panel 64 which collects light directed at the exterior of the window 12 and which will aid in powering the present invention. Various types of solar panels 64 may be utilized, and the scope of the present invention should not be construed as limited in any respect to a particular type of solar panel 64. The lower end 26 of the housing 20 may include a panel receiver 27 comprising a slot, depression, bracket, or the like for receiving and securing the solar panel 64 in a removable configuration so that it may be serviced or replaced when needed.

The lower end 26 of the housing 20 may also include components for mounting the housing 20 against a surface such as a window 12. As best shown in FIG. 14, the lower end 26 of the housing 20 is removably secured to such a surface. Various methods may be utilized for removably mounting the housing 20 to a surface, and the scope of the present invention should not be construed as limited to any particular mounting method or device shown in the exemplary figures.

In a preferred embodiment as shown in the figures, the lower end 26 of the housing 20 (e.g., on the base portion 30), may include a first mount receiver 80 and a second mount receiver 82 each adapted to removably receive a first mount 84 and a second mount 86, respectively. The first mount 84 and second mount 86 will generally comprise buttons, suction cups, adhesive connectors, or any other structure capable of being removably secured to a vertical or diagonal surface. The mount receivers 80, 82 may comprise key-holes or other slots, impressions, or the like to which the mounts 84, 86 may be removably secured. Generally, the mount receivers 80, 82 will be located on the lower end 26 of the housing 20 adjacent to its rear end 22 as shown in the figures, though other positioning may be utilized. A first bumper 87 and a second bumper 88 are generally provided on the lower end 26 of the housing 20 adjacent to its front end 21 which will rest against the window 12 or other surface when the present invention is in use.

i. Base Portion.

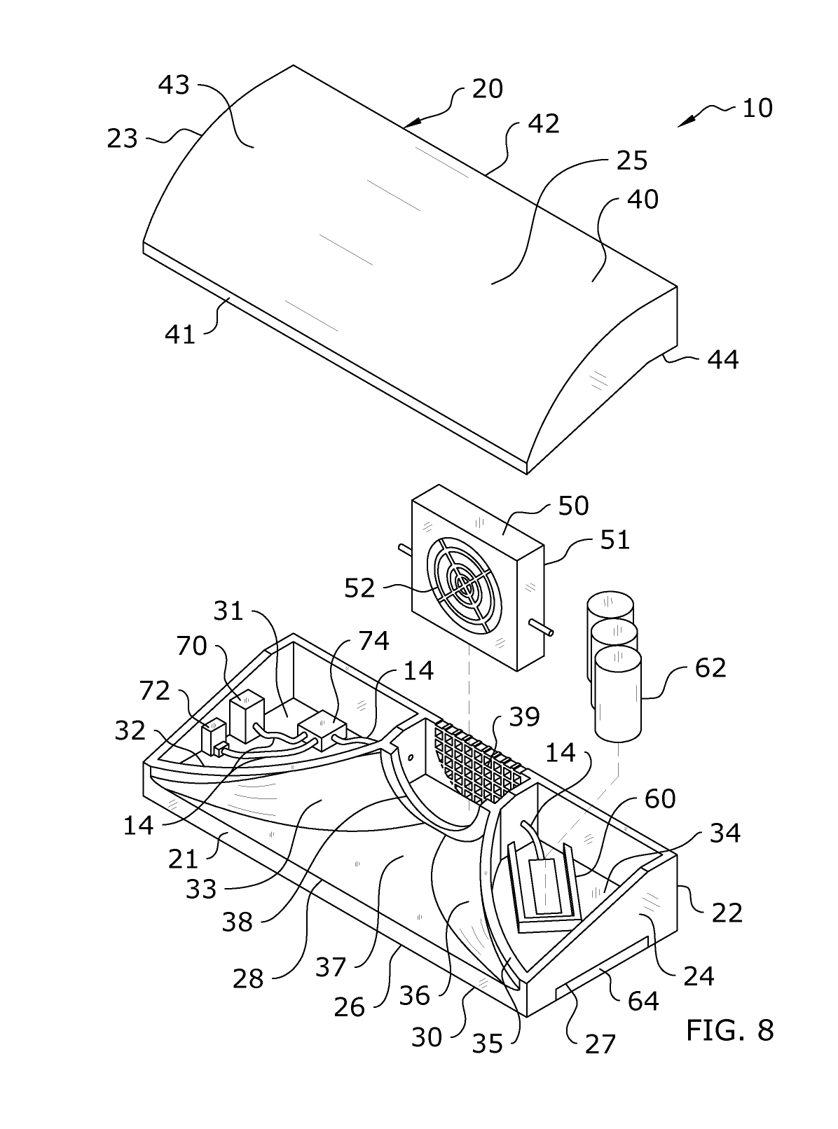

As best shown in FIG. 8, the housing 20 may comprise a base portion 30 and a cover portion 40 removably secured thereto. The base portion 30 may comprise various configurations, but will generally act as a mounting point for the various internal components of the present invention. The base portion 30 will generally include the lower air vent portion 39 which, when combined with the upper air vent portion 46, forms the complete air vent 29 of the present invention.

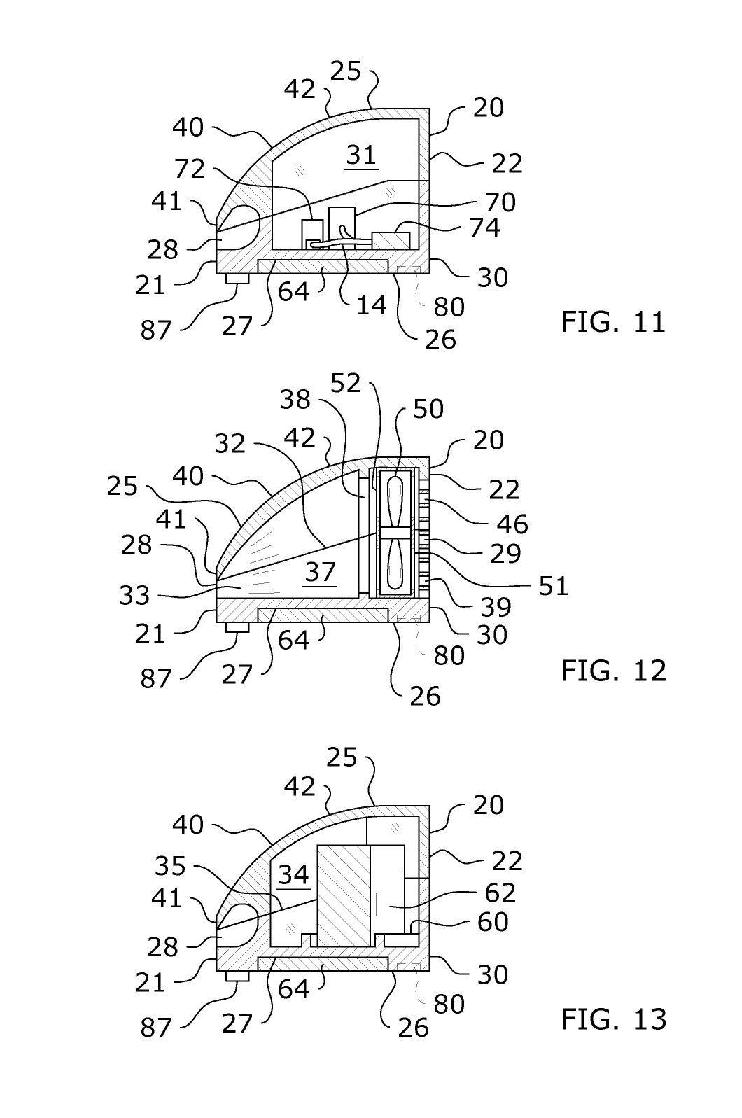

Internal to the housing 20 is a plurality of compartments 31, 34, 37 which are distinct and divided from each other. Compartment walls 32, 35 extend from the base portion 30 to the cover portion 40 such as shown in FIGS. 11-13 to define the plurality of compartments 31, 34, 37. The use of distinct compartments 31, 34, 37 aids in directing airflow as it passes through the housing 20 and out its airflow slot 28.

Generally, three distinct compartments 31, 34, 37 are utilized on the internal of the housing 20, though various other configurations may be utilized. In one such embodiment shown in FIG. 8, a first compartment 31 is defined between the first side 23 of the housing 20 and a first compartment wall 32. The first compartment wall 32 serves to separate the first compartment 31 from the remainder of the interior of the housing 20.

As best shown in FIG. 8, the first compartment wall 32 will generally extend in an arc between a position at the rear end 22 of the interior of the housing 20 and the intersection of the first side 23 and front end 21 of the interior of the housing 20. This arced configuration, in combination with a first airflow guide 33 on the outer side of the first compartment wall 32, aids in directing airflow through the third compartment 37 as will be discussed herein.

As shown in FIG. 8, a second compartment 34 is defined between the second side 24 of the housing 20 and a second compartment wall 35. The second compartment wall 35 serves to separate the second compartment 34 from the remainder of the interior of the housing 20. The second compartment wall 35 will generally extend in an arc between a position at the rear end 22 of the interior of the housing 20 and the intersection of the second side 24 and front end 21 of the interior of the housing 20. The arced configuration works in combination with the second airflow guide 36 on the outer side of the second compartment wall 34 to aid in directing airflow through the third compartment 37.

As shown in FIG. 10, the third compartment 37 is positioned between the first compartment 31 and the second compartment 34. Generally, the third compartment 37 is defined by the rear end 22 of the interior of the housing 20, the first compartment wall 32, and the second compartment wall 35. Unlike the first and second compartments 31, 34, the third compartment 37 is not fully enclosed. Airflow is directed through the third compartment 37 by entering through the air vent 29 at the rear of the third compartment 37 and being blown out the airflow slot 38 at the front of the third compartment 37.

As shown in FIG. 8, the fan 50 of the present invention is positioned within the third compartment 37. A fan divider 38, comprising a curved or semi-circular rib or the like, is positioned in the third compartment 37 to hold the fan 50 within its own receptacle at the rear of the third compartment 37. The fan divider 38 should be adapted to not impede the flow of air out of the fan 50 while still securing the fan 50 within its own receptacle of the third compartment 37.

The third compartment 37 will generally include airflow guides 33, 36 which will guide air blown from the fan 50 through the third compartment 37 and out the airflow slot 28. Generally, a first airflow guide 33 is positioned in the third compartment 37 adjacent to and along the length of the first compartment wall 32. Similarly, a second airflow guide 36 is positioned in the third compartment 37 adjacent to and along the length of the second compartment wall 35. The airflow guides 33, 36 comprise a concave surface formed along the respective compartment walls 32, 35.

ii. Cover Portion.

As shown in FIG. 8, the cover portion 40 of the present invention is removably connected on top of the base portion 30. It is preferable to use a cover portion 40 which is removably secured to the base portion 30 so that the internal components of the housing 20 may be easily accessed for maintenance, repair, or replacement. In some embodiments, there may not be a discrete cover portion 40 but instead an access window or opening which allows the internals of the housing 20 to be accessed.

The cover portion 40 comprises a front end 41, a rear end 42, an upper surface 43, and a lower surface 44. The height of the cover portion 40 will preferably taper from its rear end 42 to its front end 41, thus creating a slope on the upper surface 43. This sloped upper surface 43 aids in directing air through the housing 20 and into the airflow slot 28 to exit the housing 20. The rear end 42 of the cover portion 40 will generally include the upper air vent portion 46 which, when combined with the lower air vent portion 39, forms the complete air vent 29 at the rear end 22 of the housing 20.

### C. Control and Power

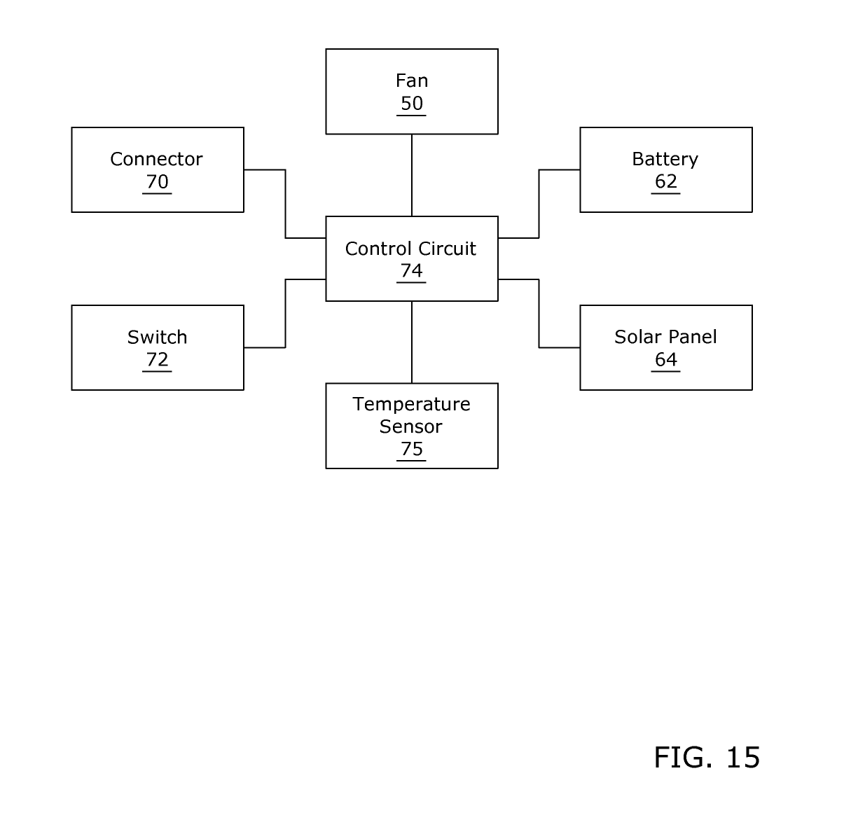

FIG. 15 illustrates the interconnection of the various components of the present invention. As shown, the present invention includes a control circuit 74 which controls and manages the overall operation of the present invention. The control circuit 74 could comprise integrated circuitry or the like which is adapted to monitor and control the components of the present invention such as the fan 50 and temperature sensor 75.

The control circuit 74 may be placed anywhere within the housing 20. In the exemplary figures, the control circuit 74 is illustrated as being positioned within the first compartment 31. It should be appreciated that the control circuit 74 could alternately be positioned in the second compartment 34, third compartment 37, or at any other location within the housing 20. The control circuit 74 may also include timing circuitry or components to control operating time of the fan 50.

The control circuit 74 is directly connected to the fan 50 to control operation of the fan 50. The fan 50, which is positioned in the third compartment 37, includes an intake 51 which faces towards the rear end 22 of the housing 20 against the air vent 29 and an output 52 which faces toward the front end 21 of the housing 20 to direct air through the third compartment 37 and out the airflow slot 28.

One or more conduits 14 may electrically connect the fan 50 with the control circuit 74 and/or the battery 62 of the present invention. The fan 50 will be monitored, managed, and controlled by the control circuit 74 as discussed herein. Various types of fans 50 may be utilized, and the present invention should not be construed as being limited to any particular type of fan 50 configurations.

To power the fan 50, the present invention will generally include a battery 62 and/or a solar panel 64. It should be noted that, while this description refers to “battery” in the singular, the present invention could in some embodiments utilize multiple batteries 62 within the single housing 20. For example, as shown in FIG. 8, the battery 62 could comprise multiple batteries 62 linked together. Preferably, the battery 62 will be rechargeable, such as a rechargeable lithium battery.

The battery 62 of the present invention may be positioned at various locations within the housing 20. In a preferred embodiment as shown in the figures, the battery 62 is positioned in the second compartment 34. A battery bracket 60 may be provided to secure the battery 62 in place within the housing 20 and to prevent the battery 60 from freely moving about in the housing 20 and potentially damaging the present invention or the battery 62 itself.

The solar panel 64 is preferably positioned on the lower end 26 of the housing 20 to be placed against the window 12 to receive light coming through the window 12. The solar panel 64 is electrically connected to the battery 62, control circuit 74, and/or fan 50. The solar panel 64 may be utilized for a number of purposes, such as but not limited to recharging the battery 62, powering the fan 50, and/or providing power to the control circuit 74. The control circuit 74 may operate the solar panel 64, such as managing when it is active or disabled.

As shown in FIGS. 7 and 15, the present invention may also include a temperature sensor 75 which senses the temperature of the surface of the window 12. The temperature sensor 75 is connected to the control circuit 74, which will direct operation of the present invention depending on the sensed temperature. The temperature sensor 75 may be positioned at various locations on the lower end 26 of the housing 20, such as next to one of the bumpers 87, 88 as shown in the figures.

The present invention also includes a connector port 70 and a switch 72. The connector port 70 may receive a power cord 16 to provide an alternate method of charging the battery 62 or operating the present invention, such as in low-light conditions. The switch 72 may be utilized to power on or power off the present invention. Although the figures illustrate the connector port 70 and switch 72 as being positioned on the first side 23 of the housing 20 and extending through the first compartment 31, it should be appreciated that the connector port 70 and switch 72 may be positioned at any location.

### D. Operation of Preferred Embodiment

In use, the mounts 84, 86 are first secured to the surface such as a window 12. Generally, adhesive or suction will removably secure the mounts 84, 86 against the window 12. The housing 20 may then be secured to the mounts 84, 86 by positioning the mount receivers 80, 82 over the mounts 84, 86 so that the mounts 84, 86 engage with the mount receivers 80, 82 to retain the housing 20 against the mounts 84, 86.

With the housing 20 secured to the window 12 such as shown in FIG. 14, the present invention may be powered on. In some embodiments, this will be accomplished by activating the switch 72. Once activated, the control circuit 74 will direct operation of the fan 50. The fan 50 may be activated on a timer or may be activated based on conditions sensed by the temperature sensor 75. For example, when the temperature sensor 75 detects moisture or condensation, the control circuit 74 may activate the fan 50 until the sensor 75 detects that the condensation or moisture has been eliminated.

In any case, the fan 50 will draw air in through the air vent 29 and into its intake 51. The air will be blown through the output 52 of the fan 50 and into the third compartment 37 of the housing 20. The air expands as it passes through the third compartment 37, which will preferably expand in width between the rear end 22 of the housing 20 and the front end 21 of the housing 20. The air is then blown out through the airflow slot 28 and onto the window 12 surface to reduce or eliminate condensation.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A condensation elimination system, comprising:
a housing, wherein said housing includes a front end, a rear end, an upper end, and a lower end;
an airflow slot at said front end of said housing;
an air vent at said rear end of said housing;
a fan positioned adjacent to said air vent for blowing air from said air vent through said housing and out said airflow slot; and
a solar panel secured to said lower end of said housing.

2. The condensation elimination system of claim 1, wherein said lower end of said housing includes a slot for removably receiving said solar panel.

3. The condensation elimination system of claim 1, wherein an interior of said housing includes a first compartment, a second compartment, and a third compartment.

4. The condensation elimination system of claim 1, wherein said first compartment is defined by said rear end of said housing, a first side of said housing, and a first compartment wall.

5. The condensation elimination system of claim 4, wherein said second compartment is defined by said rear end of said housing, a second side of said housing, and a second compartment wall.

6. The condensation elimination system of claim 5, wherein said third compartment is defined by said rear end of said housing, said first compartment wall, and said second compartment wall.

7. The condensation elimination system of claim 6, wherein said fan is positioned within said third compartment.

8. The condensation elimination system of claim 7, wherein said third compartment expands in width between said rear end of said housing and said front end of said housing.

9. The condensation elimination system of claim 8, wherein said first compartment wall and said second compartment wall each curve outwardly.

10. The condensation elimination system of claim 9, wherein said first compartment wall includes a first airflow guide and wherein said second compartment wall includes a second airflow guide.

11. The condensation elimination system of claim 1, wherein said housing comprises a base portion and a cover portion, wherein said cover portion is removably connected to said base portion.

12. The condensation elimination system of claim 1, further comprising a battery positioned within said housing.

13. The condensation elimination system of claim 12, wherein said battery is comprised of a rechargeable battery, wherein said battery is charged by said solar panel.

14. The condensation elimination system of claim 12, further comprising a control circuit for operating said fan.

15. The condensation elimination system of claim 14, further comprising a sensor for detecting a temperature of a surface on which said housing is mounted.

16. The condensation elimination system of claim 15, further comprising a switch for activating or deactivating said fan manually.

17. The condensation elimination system of claim 16, further comprising a connector port for receiving a power cord.

18. The condensation elimination system of claim 1, wherein said lower end of said housing includes at least one mount receiver and at least one bumper.

19. The condensation elimination system of claim 18, further comprising at least one mount adapted to be secured to a surface, wherein said at least one mount is adapted to be removably connected to said at least one mount receiver.

20. The condensation elimination system of claim 1, wherein said upper end of said housing includes a tapered slope between said rear end of said housing and said front end of said housing.
